(19) United States
(12) Patent Application Publication
(10) Pub. No.: US 2024/0177066 A1
(43) Pub. Date: May 30, 2024

(54) INTELLIGENT AI ARCHITECTURE SELECTION

(71) Applicant: BRITISH TELECOMMUNICATIONS PUBLIC LIMITED COMPANY, London (GB)

(72) Inventors: Adam ZIOLKOWSKI, London (GB); Alistair MCCORMICK, London (GB); Emmanuel FERREYRA OLIVARES, London (GB); Johannes NOPPEN, London (GB)

(21) Appl. No.: 18/551,481

(22) PCT Filed: Mar. 10, 2022
(86) PCT No.: PCT/EP2022/056230

§ 371 Date: Sep. 20, 2023

(30) Foreign Application Priority Data
Mar. 22, 2021 (GB) 2103917.7

(51) Int. Cl. G06N 20/00

(52) U.S. Cl. CPC G06N 20/00

(57) ABSTRACT

A computer implemented method of deploying an artificial intelligence (AI) algorithm to model a function can include defining a verification test for verifying that the AI algorithm models the function, the fitness test being defined based on a set of input/output pairs each indicating the required output of the function for an input; defining a machine learning component having a machine learning algorithm and a configuration, the machine learning algorithm being trained based on training data to model the function; iteratively adapting the machine learning component over a plurality of generations, wherein each generation of the component is adapted by modifying the configuration of the component, and wherein the adaptation for a generation is selected from a set of candidate adaptations based on a determination of a fitness of the component so adapted, the fitness being determined by the verification test, wherein the iteration ceases in response to a stopping condition such that, on cessation, a latest generation of the machine learning component is selected to constitute the AI algorithm modelling the function.

### PRIORITY CLAIM

The present application is a National Phase entry of PCT Application No. PCT/EP2022/056230, filed Mar. 10, 2022, which claims priority from GB Patent Application No. 2103917.7, filed Mar. 22, 2021, each of which is hereby fully incorporated herein by reference.

### TECHNICAL FIELD

The present disclosure relates to the selection of artificial intelligence architecture for a problem domain.

### BACKGROUND

Artificial intelligence (AI) is applied in software to address a problem domain. The selection of an AI algorithm and its configuration depends upon the problem domain and the effectiveness of the algorithm for addressing the problem. Features of AI components are multidimensional and include architectural selections (such as type(s) of algorithm(s) (e.g. regressor or classifier, long-short-term-memory, deep neural network, convolutional neural network etc.), extent of supervision in training data, training technique and the like). Also, features include hyperparameters such as learning rate, layer depth, neuron function (e.g. linear, step, sigmoid, rectifier), adjustment factors and functions, iterations, stopping conditions, and a multitude of other configurable parameters.

The selection of a “good-fit” type of AI and accompanying parameters is challenging and is not readily achieved in an automated manner to automatically deploy AI for software components. Accordingly, it would be advantageous to address these challenges.

### SUMMARY

According to a first aspect of the present disclosure, there is provided a computer implemented method of deploying an artificial intelligence (AI) algorithm to model a function comprising: defining a verification test for verifying that the AI algorithm models the function, the fitness test being defined based on a set of input/output pairs each indicating the required output of the function for an input; defining a machine learning component having a machine learning algorithm and a configuration, the machine learning algorithm being trained based on training data to model the function; iteratively adapting the machine learning component over a plurality of generations, wherein each generation of the component is adapted by modifying the configuration of the component, and wherein the adaptation for a generation is selected from a set of candidate adaptations based on a determination of a fitness of the component so adapted, the fitness being determined by the verification test, wherein the iteration ceases in response to a stopping condition such that, on cessation, a latest generation of the machine learning component is selected to constitute the AI algorithm modelling the function.

In some embodiments, the multiple machine learning components are defined, each having a machine learning algorithm and a configuration trained based on training data to model the function, and wherein the iteratively adapting is performed for each of the multiple machine learning components, the method further comprising: responsive to the stopping condition, a measure of fitness of each of the latest generation of each machine learning component are compared to select a fittest machine learning component to constitute the AI algorithm modelling the function.

In some embodiments, the configuration of the machine learning component includes one or more of: a layer depth; a neuron function; an adjustment factor; and an adjustment function.

In some embodiments, the stopping condition includes one or more of: a predetermined number of iterations; and a predetermined threshold measure of fitness determined by the verification test.

In some embodiments, at least a subset of the set of candidate adaptations is generated randomly.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an artificial intelligence software deployment component in accordance with embodiments of the present disclosure.

FIG. 3 is a flowchart of a method of deploying an artificial intelligence algorithm to model a function in accordance with embodiments of the present disclosure.

### DETAILED DESCRIPTION

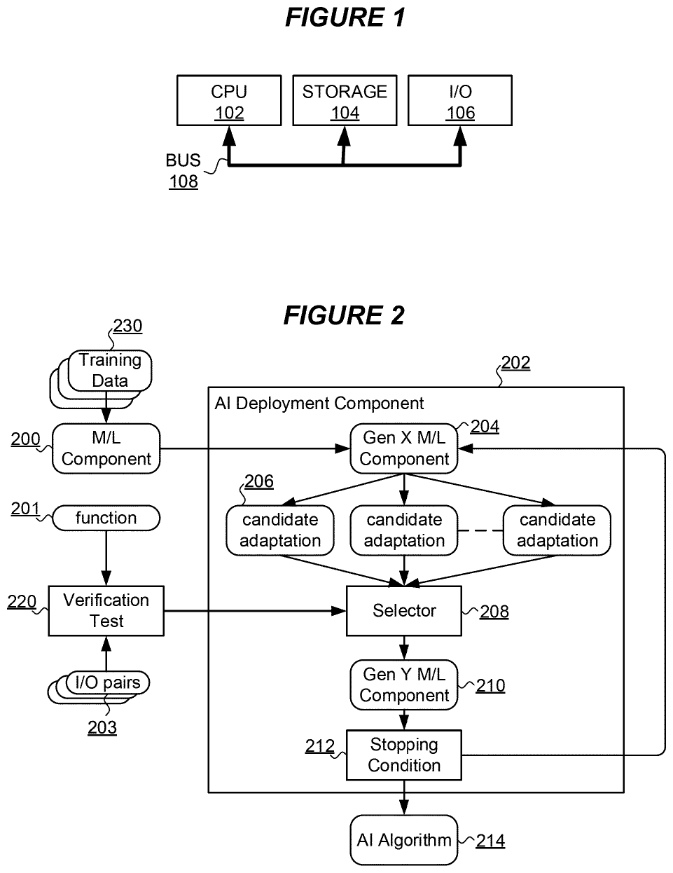

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an AI software deployment component 202 in accordance with embodiments of the present disclosure. The AI software deployment component 202 is operable to deploy an AI algorithm 214 modelling a function 201. The particular nature of the function 201 is immaterial except that the function is modellable by an AI component using machine learning methods. Thus, training data 230 is provided for training a machine learning (M/L) component 200 for modelling the function 201. Further, a set of input/output pairs 203 are provided to indicate a required output from the function 201 for a given input. The efficacy of a machine learning component such as component 200 for modelling the function 201 is assessable by a verification test 220. The verification test 220 is a software, hardware, firmware or combination component that is defined based on the set of input/output pairs 203 to verify that a machine learning component or any AI algorithm models the function 201. In some embodiments, the verification test 220 is operable to identify an extent to which a machine learning component models the function 201, such as a measure of efficacy, precision, correctness or other metric of a machine learning component.

The AI deployment component 202 is a hardware, software, firmware or combination component embodying multi-generational adaptation process as described below. The AI deployment component 202 accesses a machine learning component 200 that is defined to have a machine learning algorithm and a configuration. The machine learning algorithm of the component 200 is one of any number of suitable algorithms such as a deep neural network, a convolutional neural network, a regressor, a classifier, a long-short-term-memory, and other algorithms as will be apparent to those skilled in the art. The machine learning algorithm of the component 200 is trained based on the training data 230 to model the function 201. The configuration of the machine learning component 230 includes one or more of, inter alia: a layer depth; a neuron function; an adjustment factor; and an adjustment function. In some embodiments the machine learning component 200 is defined by the AI deployment component 202.

The AI deployment component 202 undertakes an iterative adaptation of the machine learning component 200 over a plurality of generations such that each generation of the component is adapted by modifying one or more aspects of the configuration of the component. In particular, a current generation of the machine learning component 200, indicated as Gen X component 204 (which, at a first generation, is constituted as the original machine learning component 200 itself), is processed to generate multiple candidate adaptations 206 for Gen X 204. Each candidate adaptation 206 is an adaptation to the configuration of the Gen X component 204. The adaptations can include modifications to any or all of the configuration parameters of the machine learning component. One or more of the candidate adaptation 206 can be generated by, for example, a random selection of configuration parameters and/or a random adjustment to configuration parameters. Additionally or alternatively, candidate adaptations 206 can be generated based on a previous adaptation on which basis the Gen X component 204 was constituted.

A selector component 208 is a hardware, software, firmware or combination component operable to select a candidate adaptation 206 from the set of candidates on which basis a next generation of the component will be constituted, indicated as Gen Y component 210. The selector 208 is operable to select based on a determination of a fitness of each candidate adaptation 206 by determining a fitness of the Gen X component 204 so adapted by each candidate adaptation 206. The fitness is determined based on the verification test 220 for verifying if the Gen X component 204 so adapted by a candidate adaptation 206 suitably models the function 201. In some embodiments, the fitness determination is binary such that the component so adapted is determined to be fit or not fit based on the verification test 220. Alternatively, the fitness determination can be non-binary such as by a measure of fitness based on, for example, an extent to which the function 201 is modelled where such extent can be measured in such a way.

Thus, the selector 208 selects a most fit candidate adaptation 206 as the next generation Gen Y component 210. In some embodiments, where two or more candidate adaptations 206 are deemed equally fit, then the selector 208 may select between them such as by random selection. In some embodiments, where multiple candidate adaptations 206 are equally fit or equally satisfy a fitness threshold, multiple instances of the AI deployment component 202 can be executed each based on a different one of the fit candidate adaptations. In such embodiments, a further selection can be required between a final generation identified by each instance of the deployment component 202, such as by using selection criteria including a degree of fitness of the final generations or the like.

The genetic algorithm 202 iterates such that the Gen Y component 210 determined by the selector 208 becomes the new Gen X component 204 at a subsequent iteration on which bases further candidate adaptations are determined for selection therebetween. In this way, the software component 200 is gradually adapted by removal of portions thereof over the iterative process of the genetic algorithm 202.

The AI deployment component 202 includes a stopping condition 212 for determining when the iteration will cease. For example, the stopping condition 212 can includes one or more of, inter alia: a predetermined number of iterations; and a predetermined threshold measure of fitness determined by the verification test 220. On satisfaction of the stopping condition 212, the cessation of the iteration leaves a latest generation of the component which is used to constitute the AI algorithm 214.

In some embodiments, multiple machine learning components 200 are defined, each having a machine learning algorithm and a configuration trained based on training data to model the function 201. In such embodiments, the AI deployment component 202 is further operable to iteratively adapt each such machine learning component such that, on satisfaction of the stopping condition 212, a measure of fitness of each of the latest generations of each machine learning component are compared to select a fittest machine learning component to constitute the AI algorithm.

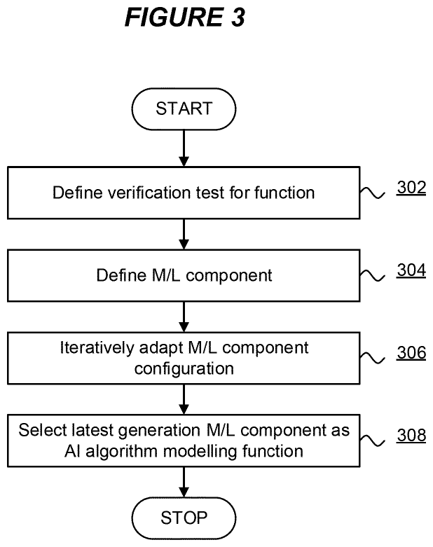

FIG. 3 is a flowchart of a method of deploying an artificial intelligence algorithm 214 to model a function 201 in accordance with embodiments of the present disclosure. Initially, at 302, the method defines the verification test 220 for verifying that an AI algorithm models the function 201. At 304 the method defines a machine learning component 200 trained based on the training data 230 to model the function 201. At 306 the method iteratively adapts a configuration of the machine learning component over multiple generations until a stopping condition is reached. At 308 a latest generation of the machine learning component is selected as the AI algorithm 214.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the claims.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of deploying an artificial intelligence (AI) algorithm to model a function comprising:
defining a verification test for verifying that the AI algorithm models the function, the verification test being defined based on a set of input/output pairs each indicating a required output of the function for an input;
defining a machine learning component having a machine learning algorithm and a configuration, the machine learning algorithm being trained based on training data to model the function; and
iteratively adapting the machine learning component over a plurality of generations, wherein each generation of the component is adapted by modifying the configuration of the component, and wherein the adaptation for a generation is selected from a set of candidate adaptations based on a determination of a fitness of the component so adapted, the fitness being determined by the verification test,
wherein the iterative adapting ceases in response to a stopping condition such that, on cessation, a latest generation of the machine learning component is selected to constitute the AI algorithm modelling the function.

2. The method of claim 1, wherein the multiple machine learning components are defined, each having a machine learning algorithm and a configuration trained based on training data to model the function, and wherein the iterative adapting is performed for each of the multiple machine learning components, the method further comprising:
responsive to the stopping condition, a measure of fitness of each of the latest generation of each machine learning component are compared to select a fittest machine learning component to constitute the AI algorithm modelling the function.

3. The method of claim 1, wherein the configuration of the machine learning component includes one or more of: a layer depth; a neuron function; an adjustment factor; or an adjustment function.

4. The method of claim 1, wherein the stopping condition includes one or more of: a predetermined number of iterations; or a predetermined threshold measure of fitness determined by the verification test.

5. The method of claim 1, wherein at least a subset of the set of candidate adaptations is generated randomly.

6. A computer system comprising a processor and memory storing computer program code for performing the method of claim 1.

7. A non-transitory computer-readable storage medium comprising computer program code to, when loaded into a computer system and executed thereon, cause the computer system to perform the method as claimed in claim 1.
